(19) United States
(12) Patent Application Publication
(10) Pub. No.: US 2009/0292692 A1
(43) Pub. Date: Nov. 26, 2009

(54) Information Search Method and Information Processing Apparatus

(75) Inventor: Takahisa Kaihotsu, Musashino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/391,125

(22) Filed: Feb. 23, 2009

(30) Foreign Application Priority Data
May 21, 2008 (JP) 2008-133332

(51) Int. Cl. G06F 17/30

(52) U.S. Cl. 707/5; 707/3; 707/E17.014; 707/E17.015

(57) ABSTRACT

According to one embodiment, an information processing apparatus includes an information acquisition processing module, a scheduling module and a control module. The information acquisition processing module performs an information acquisition process of acquiring information corresponding to an input keyword via an Internet by transmitting the keyword to a predetermined server apparatus on the Internet via the data communication module. The scheduling module acquires a date and time which is relevant to the input keyword, and records the date and time together with the input keyword. And then, the control module causes the information acquisition processing module to timely re-perform an information acquisition process using the keyword recorded by the scheduling module together with the date and time based on the date and time recorded by the scheduling module.

### CROSS-REFERENCE TO RELATED APPLICATIONS

This application is based upon and claims the benefit of priority from Japanese Patent Application No. 2008-133332, filed May 21, 2008, the entire contents of which are incorporated herein by reference.

### BACKGROUND

1. Field

One embodiment of the invention relates to an information search technique for timely searching for information corresponding to a keyword among information items disclosed on the Internet and updated at desired time according to a time factor, for example.

2. Description of the Related Art

Recently, the Internet is markedly and popularly utilized and now surpasses television broadcasts, newspapers, magazines and the like as a source of the latest information. Further, when target information is acquired from an excessively large amount of information items disclosed on the Internet, it is common practice to search for the information by use of a keyword.

Information disclosed on the Internet is generated and updated at irregular times. Therefore, in order to acquire the target newest information, it is necessary to periodically perform the search. If the user forgets to perform the search, he/she may fail to acquire the information. Based on the above fact, various proposals for timely acquiring the target newest information are made up to now (for example, see Jpn. Pat. Appln. KOKAI Publication No. 2002-169833).

An information search notifying system described in the above Jpn. Pat. Appln. KOKAI Publication No. 2002-169833 has a function of setting (scheduling) a keyword and the date-and-time at which the search is to be performed by use of the keyword. That is, it becomes possible to automatically perform the search by taking the adequate time into consideration for each keyword.

However, in the above Jpn. Pat. Appln. KOKAI Publication No. 2002-169833, it is assumed that the scheduling operation is performed by the user. Therefore, the user must determine the time at which the search is to be performed by use of the keyword for each keyword. The requirement for the user to perform the operation of setting a keyword and the date-and-time at which the search is to be performed by use of the keyword greatly spoils the usability of the system as an information search tool. As a result, a case where a specially provided function cannot be utilized occurs in some cases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a configuration of an information processing apparatus according to a first embodiment of this invention and a configuration of an information search system to which the information processing apparatus is applied.

FIG. 2 is an exemplary diagram showing a time ontology graph managed by the information processing apparatus of the embodiment.

FIG. 3 is an exemplary diagram showing a scheduling table managed by the information processing apparatus of the embodiment.

FIG. 4 is an exemplary flowchart for illustrating a passive search setting process performed by the information processing apparatus of the embodiment.

FIG. 5 is an exemplary diagram showing a passive search setting screen displayed by the information processing apparatus of the embodiment.

FIG. 6 is an exemplary flowchart for illustrating an active search performed by the information processing apparatus of the embodiment.

FIG. 7 is an exemplary diagram showing an active search screen displayed by the information processing apparatus of the embodiment.

FIG. 8 is an exemplary diagram showing an active search result displayed by the information processing apparatus of the embodiment.

FIG. 9 is an exemplary diagram showing a search for a search keyword node on a time ontology graph performed by the information processing apparatus of the embodiment.

FIG. 10 is an exemplary diagram showing a search for an instance node from the search keyword node on the time ontology graph performed by the information processing apparatus of the embodiment.

FIG. 11 is an exemplary first flowchart for illustrating a passive search performed by the information processing apparatus of the embodiment.

FIG. 12 is an exemplary second flowchart for illustrating a passive search performed by the information processing apparatus of the embodiment.

FIG. 13 is an exemplary conceptual diagram showing the principle of a passive search performed by the information processing apparatus of the embodiment.

FIG. 14 is an exemplary diagram showing notification of the result of a passive search performed by the information processing apparatus of the embodiment.

FIG. 15 is an exemplary diagram showing a scheduling table after the passive search is performed by the information processing apparatus of the embodiment.

FIG. 16 is an exemplary diagram showing a configuration of an information processing apparatus according to a second embodiment of this invention and a configuration of an information search system to which the information processing apparatus is applied.

### DETAILED DESCRIPTION

Various embodiments according to the invention will be described hereinafter with reference to the accompanying drawings. In general, according to one embodiment of the invention, an information processing apparatus includes an information acquisition processing module, a scheduling module and a control module. The information acquisition processing module performs an information acquisition process of acquiring information corresponding to an input keyword via an Internet by transmitting the keyword to a predetermined server apparatus on the Internet via the data communication module. The scheduling module acquires a date and time which is relevant to the input keyword, and records the date and time together with the input keyword. And then, the control module causes the information acquisition processing module to re-perform an information acquisition process using the keyword recorded by the scheduling module together with the date and time based on the date and time recorded by the scheduling module.

### First Embodiment

First, a first embodiment of this invention is explained.

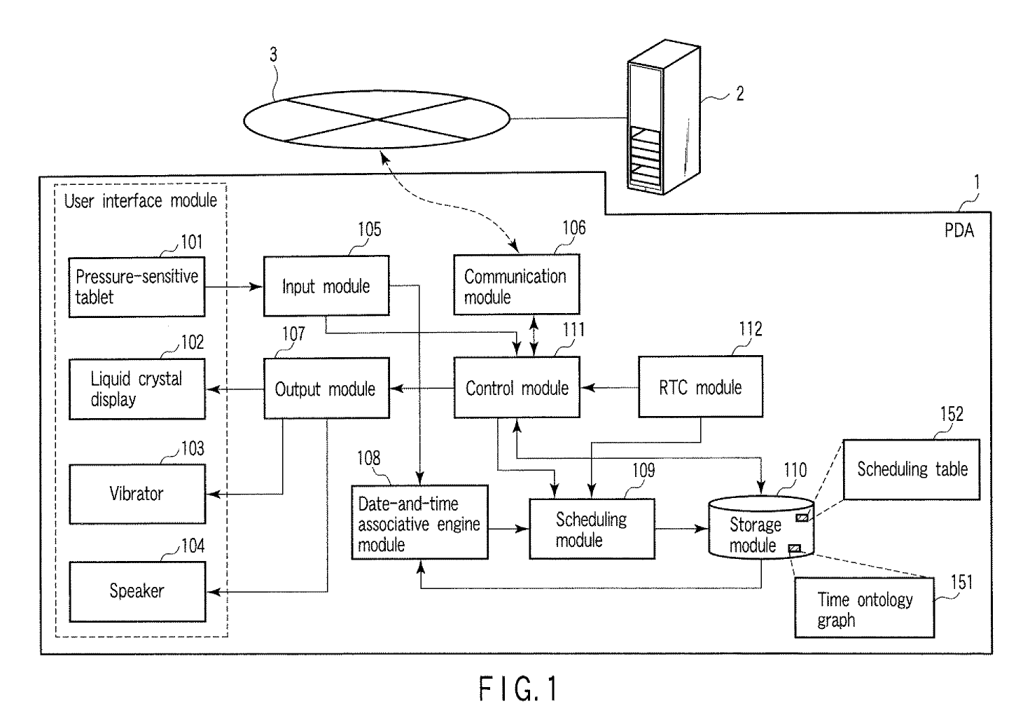

In FIG. 1, an example of the configuration of an information processing apparatus according to the present embodiment and an example of the configuration of an information search system to which the information processing apparatus is applied are shown. In this case, it is supposed that the information processing apparatus is realized as a personal portable information terminal (PDA: personal digital assistant) 1, for example.

As shown in FIG. 1, the PDA 1 is connected to a server 2 that is a search engine via the Internet 3. The PDA 1 receives a keyword input by the user and transmits the keyword to the server 2 via the Internet 3. The server 2 that has received the keyword searches for information corresponding to the keyword on the Internet 3 and returns the searched information to the PDA 1. Then, the PDA 1 indicates the returned information to the user as the search result for the input keyword.

As shown in FIG. 1, the PDA 1 includes a pressure-sensitive tablet 101, liquid crystal display 102, vibrator 103, speaker 104, input module 105, communication module 106, output module 107, date-and-time associative engine module 108, scheduling module 109, storage module 110, control module 111, real time clock (RTC) module 112 and the like.

The pressure-sensitive tablet 101 is a device to detect a portion against which a stylus pen is pressed and input a coordinate position. As the stylus pen, a rod-like plastic member is used. In this embodiment, it is used to start an information search tool, input a search keyword by use of a software keyboard that is widely known and the like, for example. Further, in this embodiment, the operation of positively performing the search to search for information by the user is referred to as an active search. On the other hand, the operation of automatically searching for information by the PDA 1 is referred to as a passive search.

The liquid crystal display 102 is a liquid crystal display device. It is a device that displays a software keyboard used to input a search keyword and a search result and is connected to the output module 107. The vibrator 103 is a vibration generator device that draws user's attention based on the known technique used in portable telephones and is connected to the output module 107. The speaker 104 is a device that outputs a buzzer sound or audio sound and is connected to the output module 107.

The pressure-sensitive tablet 101, liquid crystal display 102, vibrator 103 and speaker 104 are basic input/output devices that configure a user interface module to provide a graphical user interface (GUI).

The input module 105 is a device for performing an operation of inputting a search keyword, for example. It displays a keyboard on the screen and inputs a character by clicking a key on the screen by use of the stylus pen. An input character is determined by comparing the key arrangement on the screen and a coordinate value acquired by use of the stylus pen. Further, the process can be started by clicking one of various buttons arranged on the screen by using the stylus pen in the same method as described above.

The communication module 106 is LAN system hardware for connection with the Internet 3 that is called a mobile WiMAX, for example. In this embodiment, it is supposed that wireless communication is used, but it is of course possible to perform the communication by use of a wired LAN.

The output module 107 is connected to the liquid crystal display 102, vibrator 103, speaker 104 and control module 111. In the present embodiment, the output module 107 outputs an Internet search result to the liquid crystal display 102. It has a function of outputting a voice message of “newly received information is present” when the search result is displayed, for example. The voice synthesizing technique is widely known as a speech synthesizer, for example. Further, it is also possible to vibrate the PDA 1 by energizing the vibrator 103. The functions of the output module 107 are performed in response to commands from the control module 111.

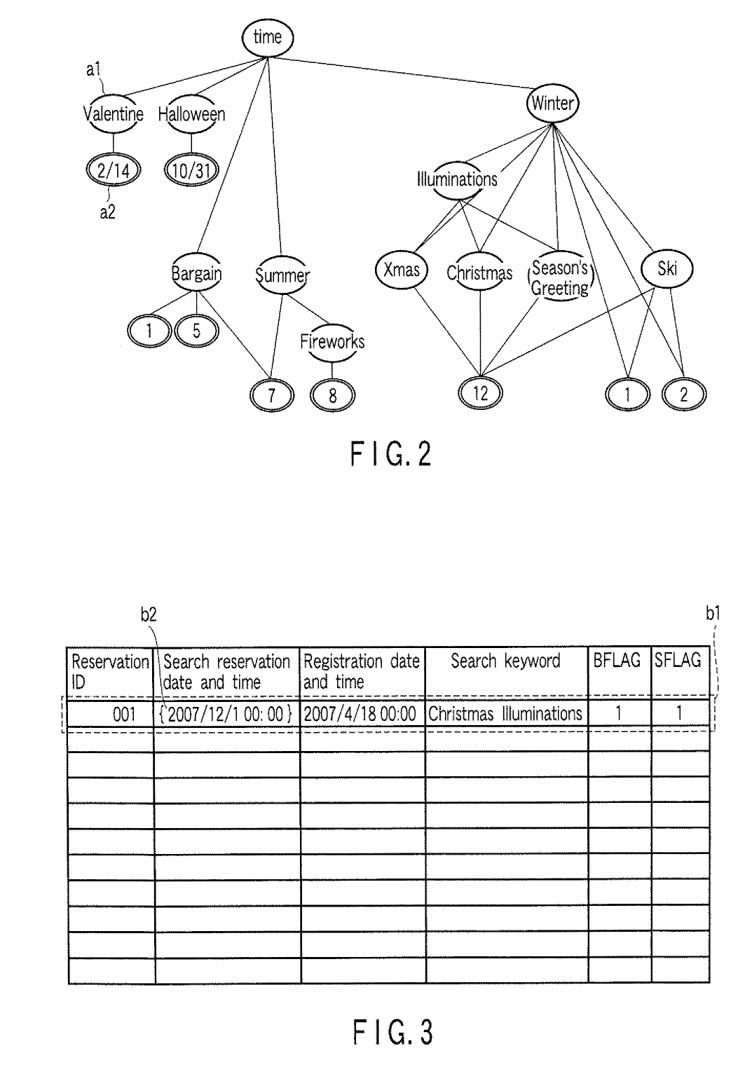

The date-and-time associative engine module 108 determines the date and time associated with the search keyword based on the input search keyword and a time ontology graph 151 stored in the storage module 110. In this case, the graph is formed by nodes and edges and is a set of binomial relations in which every two nodes are connected via an edge. Further, the ontology explicitly shows the concept based on a knowledge base and the mutual relation between the concepts. Particularly, in this embodiment, a dictionary in which vocabularies and the dates and times associated with the vocabularies are related is defined as a time ontology graph. An example of the time ontology graph 151 is shown in FIG. 2.

In FIG. 2, an intermediate node (“a1”) indicates a vocabulary and a leaf node (“a2”) indicates the date and time associated with the vocabulary. A single numeral described as the date and time in the leaf node indicates a “month”. For example, “12” indicate December.

The scheduling module 109 registers the date and time derived by the date-and-time associative engine module 108 into a scheduling table 152 together with a search keyword and the like. An example of the scheduling table 152 is shown in FIG. 3.

As shown in FIG. 3, the scheduling table 152 includes various items (fields) of a reservation number (reservation ID) for a passive search, a list of a date and time for performing the passive search (search reservation date and time), a date and time at which reservation is registered (registration date and time), a search keyword used when the passive search is performed, a flag indicating whether or not the vibrator is activated when newly received information is present (BFLAG) and a flag indicating whether or not a sound is output (SFLAG). In this example, one row of data sets (“b1”) of the table containing the above items is referred to as entry. Although not shown in FIG. 1, the scheduling module 109 has a RAM used to hold a date-and-time list (that will be described later) that is a working area used for formation of the scheduling table 152.

The storage module 110 is a storage device that stores various data items containing the time ontology graph 151 and scheduling table 152. For example, it is a storage device such as a hard disk drive or memory card.

The control module 111 is a processor that controls the operation of the PDA 1. Although not shown in FIG. 1, the control module 111 has a ROM that stores a control program and a RAM that stores a text buffer required in a process to be described later and other working data items, for example.

First, the control module 111 executes software that realizes the function of a software keyboard and browser software that displays a web page while tracing the link state of a hypertext. When the user inputs a keyword, the PDA 1 can perform the search by use of the server 2 that is a search engine on the Internet 3 based on the browser software (active search). Further, the control module 111 scans the scheduling table 152 to check whether or not the search (passive search) to be performed at the same date and time is provided based on the present date and time acquired from the RTC module 112. If such a search is provided, the control module 111 extracts a search keyword from the search keyword field of the scheduling table 152, transmits the search keyword to the browser software and performs the search by use of the server 2 that is a search engine on the Internet 3.

Further, the control module 111 performs a filtering process of analyzing the search result (text), determining whether or not the search result is newly received information by comparing the date and time at which the search result is registered with the date and time at which the passive search is performed and displaying to that effect.

The RTC module 112 is a built-in clock module having an independent power source and is referred to for causing the scheduling module 109 and control module 111 to acquire the present date and time so as to perform the passive search.

Next, in the PDA 1 with the above configuration, the operations of (1) permitting the user to set the passive search based on the GUI by use of the stylus pen, (2) permitting the user to input a search keyword by use of the software keyboard, perform the active search by using the search engine on the Internet and schedule the passive search in the process, and (3) performing the passive search when the scheduled date and time is reached are explained below.

(1) Passive Search Setting Operation:

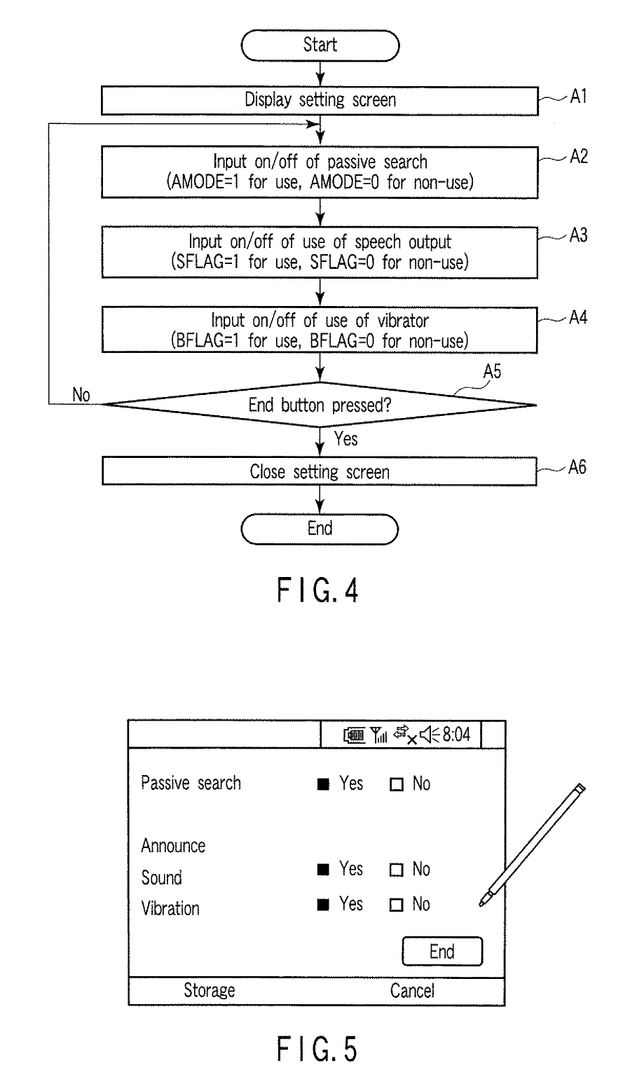

FIG. 4 is a passive search setting flow by the user. The setting is made according to the pressure-sensitive tablet 101 by using a widely known GUT as shown in FIG. 5.

First, a setting GUI screen of FIG. 5 is displayed (block A1) and whether (YES-1) or not (NO-0) the passive search is performed is specified (block A2). If the setting is NO (AMODE=0), the passive search is not performed. In this embodiment, “YES (AMODE=1)” is selected.

In the case of the passive search, since the search is performed at timing that the user does not intend, it is considered that he is not aware of display of the search result. In order to cope with the above problem, one of the functions that notifies that newly received information is present is attained by use of a sound (voice) and, for this purpose, whether (YES) or not (NO) the function is utilized is specified (block A3). When YES is specified, the entry of the passive search schedule is registered with SFLAG=1 (when NO is specified, it is registered with SFLAG=0). In this embodiment, “YES (SFLAG=1)” is selected.

Likewise, in the function of informing that newly received information is present, a vibrator (vibration) is provided in addition to a sound (voice), and therefore, whether (YES) or not (NO) the function is utilized is specified (block A4). When YES is specified, the entry of the passive search schedule is registered with BFLAG=1 (when NO is specified, it is registered with BFLAG=0). The vibration function is a widely known function in the field of portable telephones and the like. In this embodiment, “YES (BFLAG=1)” is selected.

Then, when it is detected that the end button of the GUI of FIG. 5 is depressed (YES in block A5), the setting GUI screen is closed and the passive search setting process is terminated (block A6). If it is not detected that the end button is depressed (NO in block A5), the process returns to the setting input step.

(2) Active Search:

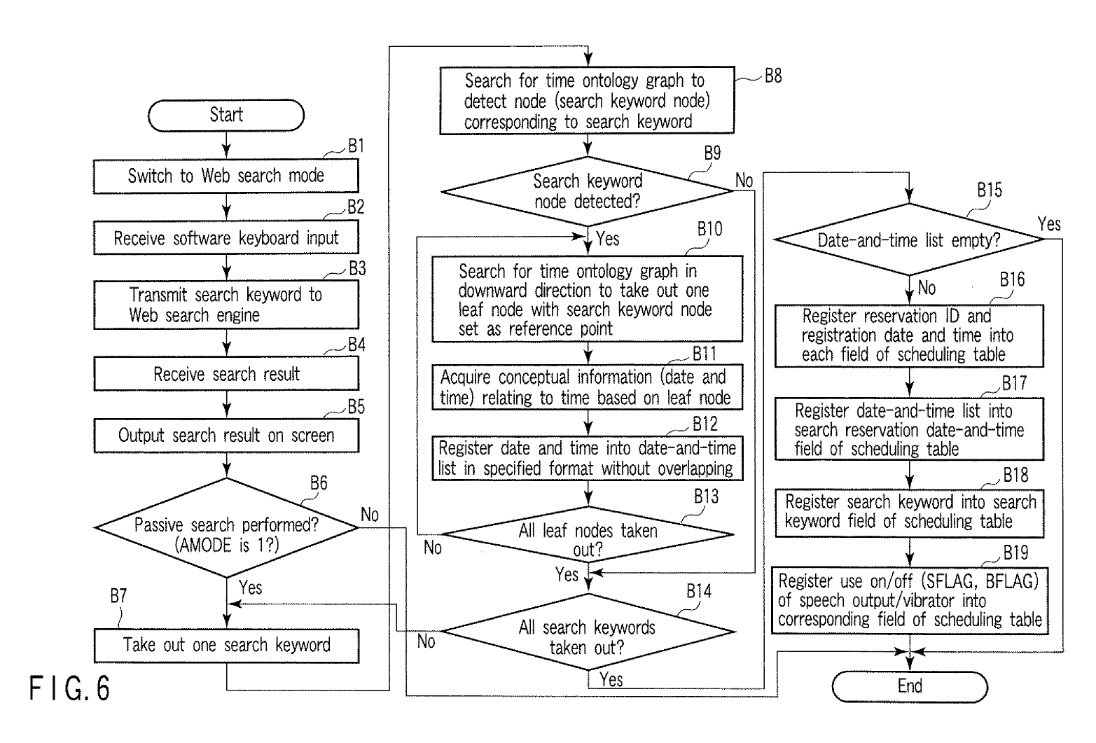

FIG. 6 shows an active search flow. The active search flow is a flow in which the user himself/herself performs an Internet search. When the active search is performed, reservation of the passive search (formation of the scheduling table 152) is made. In this case, it is supposed that the date and time at which the active search is performed is “0:0, Apr. 18, 2007”.

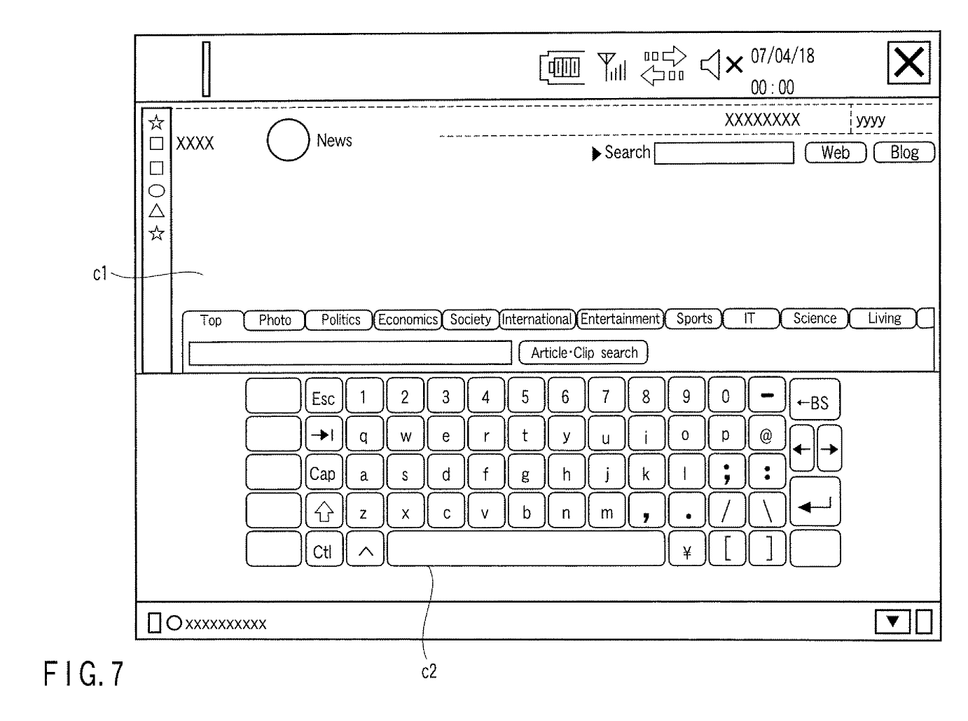

In FIG. 6, the process of blocks B1 to B5 is the same as the process of a case wherein the Internet search is performed by use of the conventional PDA, for example. As shown in FIG. 7, for example, the search is performed by use of a search engine by displaying a Web browser (“c1”) and software keyboard (“c2”) and inputting a search keyword.

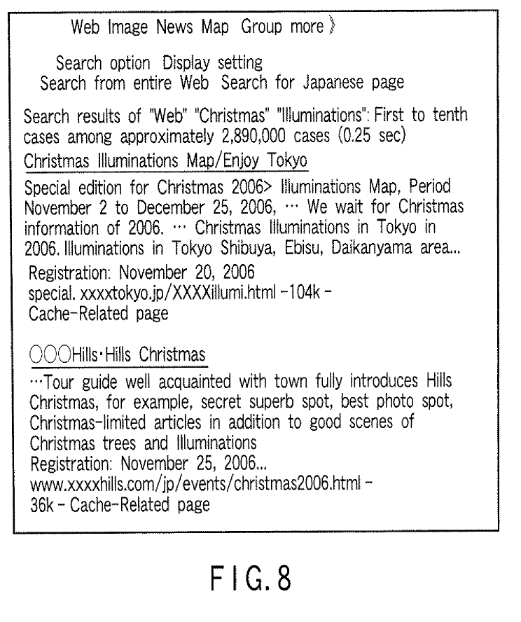

In this embodiment, two search keywords of “Christmas Illumination” that are separated by a space are input. Since information of Christmas in 2007 is not yet registered at the time of April, the search result of “Christmas Illumination” of the preceding year of 2006 is displayed on the liquid crystal display 102 as shown in FIG. 8.

As described above, in this embodiment, since it is specified that the passive search is performed in the passive search setting flow shown in FIG. 4 (AMODE=1) (YES in block B6), the reservation process for the passive search of blocks B7 to B19 is performed.

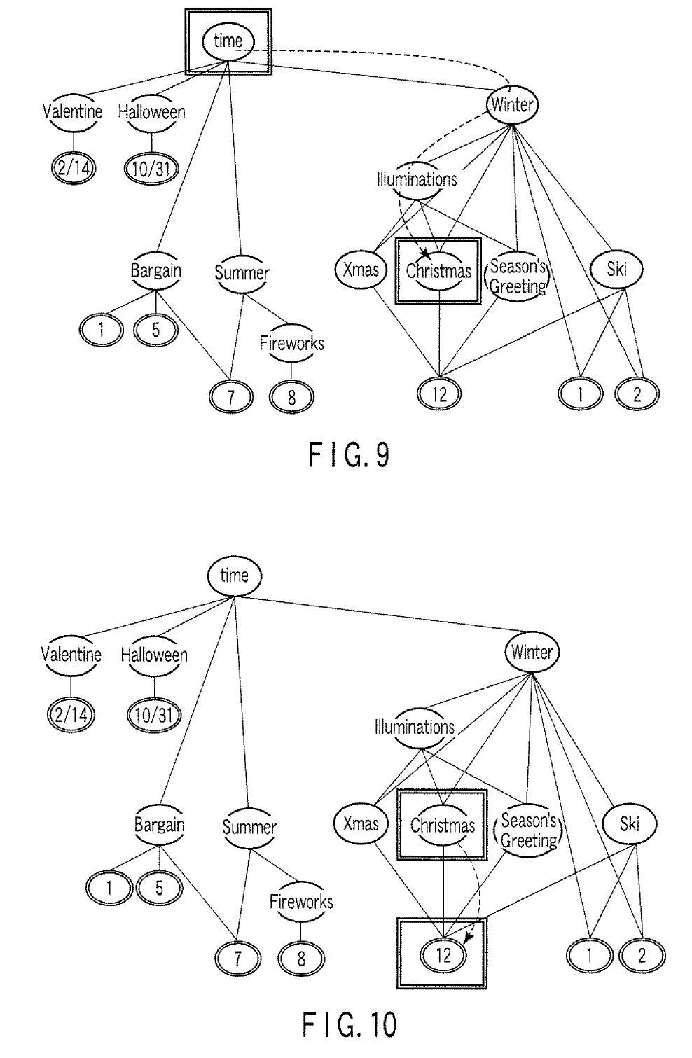

First, the date-and-time associative engine module 108 extracts “Christmas” that is one of the search keywords (block B7). Then, it searches for a time ontology graph 151 of the storage module 110 from the route node (time) and detects an intermediate node corresponding to a vocabulary of “Christmas” (block B8). As a result, as shown in FIG. 9, since a “Christmas” node is detected, a “12” node is determined as shown in FIG. 10 by searching for a graph in the downward direction up to the leaf node that indicates time with the above node set as a reference point (blocks B9 to B11). That is, the relation between the vocabulary of “Christmas” and “12” or December is derived according to the time ontology graph 151.

Next, the scheduling module 109 that has received “12” registers the same into a date-and-time list that is not explicitly shown in FIG. 1 with a specified format. The specified format indicates two sets (YYYY/MM/DD HH:MM) separated by a space and respectively containing a year, month and date (YYYY/MM/DD) separated by slashes and hour and minute (HH:MM) separated by a colon and they are the factors of the date-and-time list (“b2” of FIG. 3).

The date-and-time list is a list having at least one date and time related to a search keyword used in one active search and separated by a comma. For example, the date-and-time list containing three dates and times is expressed as follows.

{YYYY/MM/DD HH:MM, YYYY/MM/DD HH:MM, YYYY/MM/DD HH:MM}

When a date and time is registered with the specified format, the date and time is adequately extended. For example, the “year” is extended to “2007/12” if the active search date is before 2007/12 and it is extended to “2008/12” of the next year if the search date is after 2007/12. That is, the extension is made so that the reservation date of the passive search will come after the active search date. Further, the “date” is extended to “1” that is the first date of the month and the “hour and minute” is extended to “00:00 am” that is the beginning of the day.

“12” derived by use of the time ontology graph 151 is registered after it is subjected to the date-and-time extension process and the date-and-time list becomes {2007/12/1 00:00} (block B2). Since the leaf node that is connected to the “Christmas” node is only “12” (YES in block B13), the process proceeds to the succeeding block. At this time, since “Illumination” remains as the second search keyword (NO in block B14), the process returns to block B7.

In blocks B7 to B11, “Illumination” is extracted as a next search keyword and the same process is performed. In this case, the “12” node that is the same as in the case of “Christmas” is derived. Since {2007/12/1 00:00} is already registered as a date and time associated with “Christmas” in the date-and-time list, the duplicated registration is avoided and only {2007/12/1 00:00} is registered in the date-and-time list (block B12).

Since all of the search keywords have been taken out after the search keywords were taken out twice (YES in block B14), the scheduling module 109 performs the succeeding entry formation process of the scheduling table 152.

Since {2007/12/1 00:00} is registered in the date-and-time list and the list is not empty (NO in block B15), an entry in which various items containing a numeral (for example, 001) used to identify reservation of the passive search, a search reservation date and time {2007/12/1 00:00} indicating timing in which the passive search is performed, a date and time {2007/4/18 00:00} at which reservation is registered, search keywords “Christmas Illumination” used when the passive search is performed, a flag (BFLAG) 1 indicating whether or not the vibrator is activated when newly received information is present and a flag (SFLAG) 1 indicating whether or not a sound is output are set in the scheduling table 152 of the storage module 110 is formed (blocks B16 to B19). In FIG. 3, the state of the scheduling table 152 when the entry is formed is shown.

(3) Passive Search:

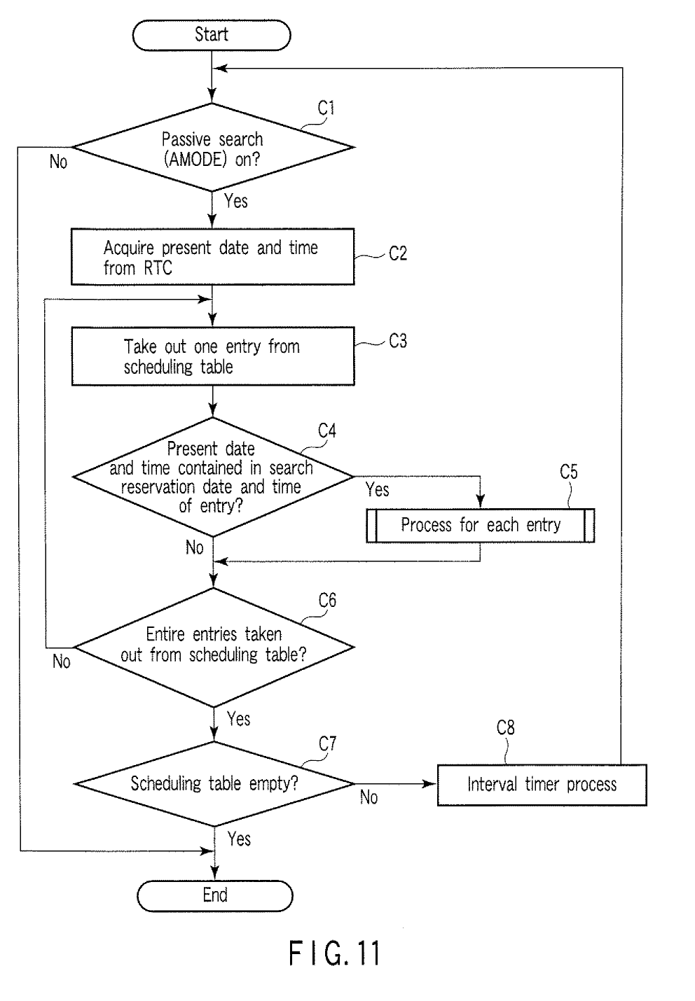

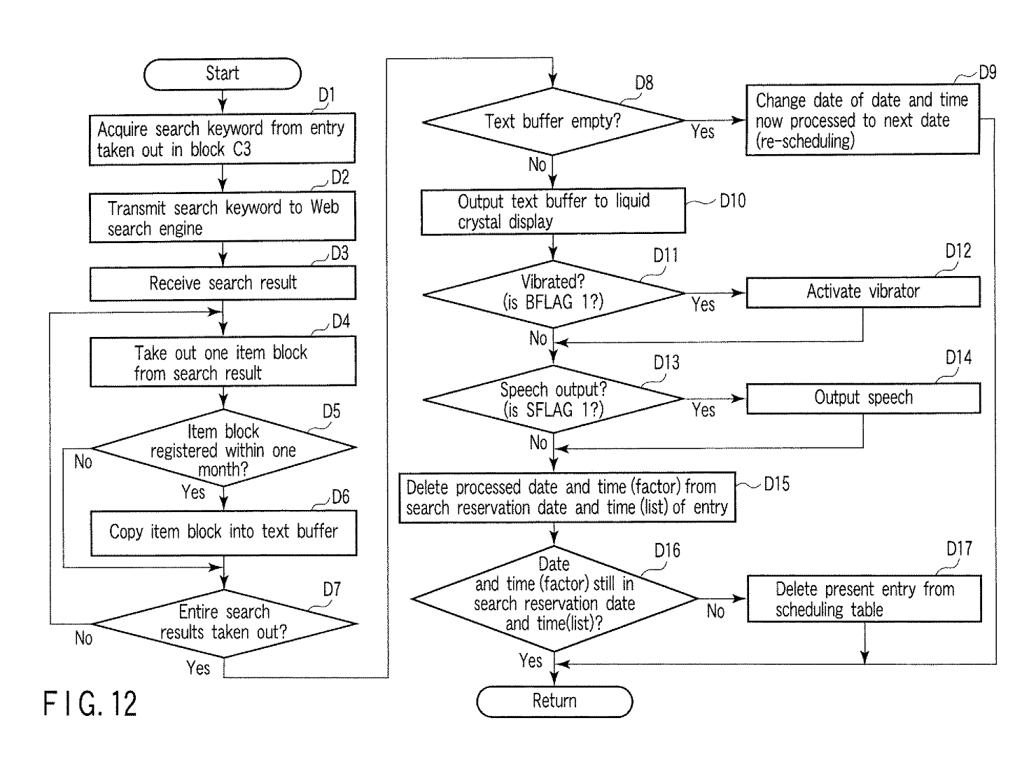

In FIGS. 11 and 12, a passive search flow is shown. The passive search flow is a flow executed by the control module 111 when the AMODE flag is YES and the scheduling table 152 is not empty. That is, the PDA 1 automatically performs an Internet search based on the scheduling table 152 formed in the active search flow shown in FIG. 6. It is now assumed that the date and time indicated by the RTC module 112 is {2007/12/1 00:00} and the scheduling table 152 is set in the state shown in FIG. 3.

Since the passive search is set ON (AMODE=1) (YES in block C1), the control module 111 performs the passive search. Since the date and time indicated by the RTC module 112 is {2007/12/1 00:00} (block C2) and {2007/12/1 00:00} is attained if the search reservation date and time of the single entry registered in the scheduling table 152 is taken out (block C3, YES in block C4), the control module 111 performs a process for the entry (block C5). FIG. 12 shows the detail operation flow of block C5 of FIG. 11.

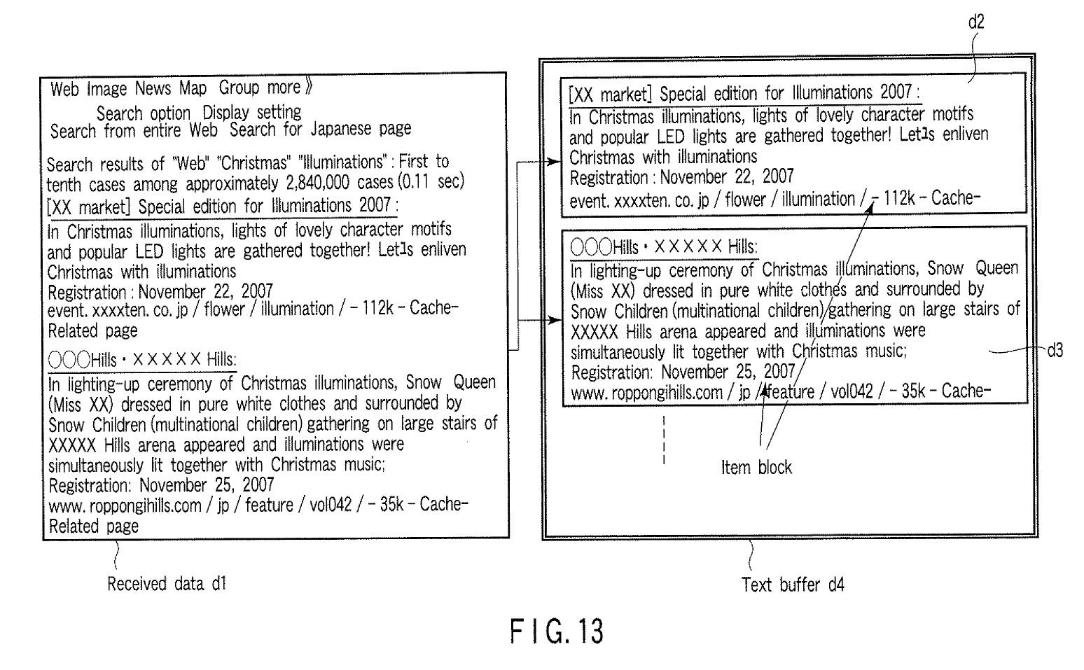

If the search keyword is taken out from the entry of the scheduling table 152, “Christmas Illumination” is derived (block D1). Then, if the Internet search is performed by use of “Christmas Illumination”, the search result (“d1”) shown in FIG. 13 is derived (blocks D2 to D3).

At this time, one item block (“d2”, “d3”, . . . ) is taken out from the search result (block D4). In this case, it is supposed that the registered date is described in each item block. In this example, for simplicity of the explanation, it is supposed that newly received information is determined according to whether information is registered within one month from the search reservation date and time or not (block D5) and whether or not the block of the same item is copied in the text buffer (“d4”) that lies in the working area of the RAM of the control module 111. In the present embodiment, since all of the search results (“d1”, “d2”, . . . ) lie within one month (YES in block D5), all of the results are copied in the text buffer.

Thus, since the text buffer is not empty (NO in block D8), the control module 111 transmits the content of the text buffer (“d4”) to the output module 107 that in turn outputs the same to the liquid crystal display 102 and, at the same time, activates the vibrator 103 and causes the speaker 104 to generate sound output (block D10.

If the text buffer is empty (YES in block D8), that is, if newly received information is not provided although the passive search is performed, the re-scheduling process is performed (block D9). Specifically, the date and time of 2007/12/1 during the process is changed to a next day of 2007/12/2 (2007/12/1 00:00→2007/12/2 00:00).

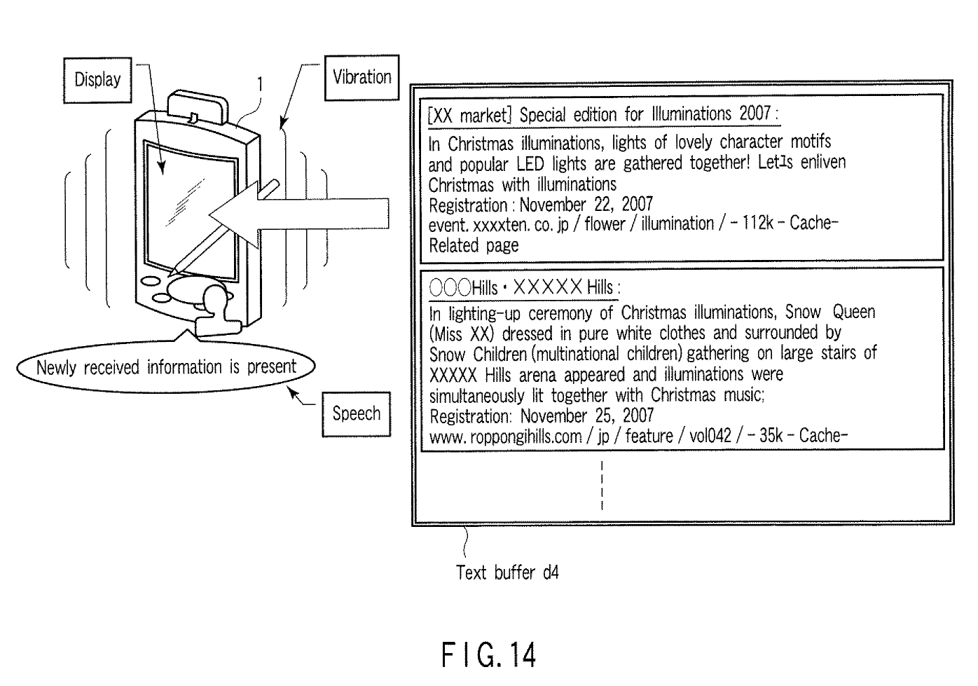

In this embodiment, since the setting of the sound and vibration is YES, the control module 111 supplies a sound output command and a vibration command of the vibrator to the output module 107 (blocks D11 to D14). As a result, as shown in FIG. 14, the PDA 1 is vibrated and, at the same time, a sound to the effect that newly received information is present is issued and the result of the passive search is displayed on the liquid crystal display 102.

When the above processes are completed, the control module 111 deletes {2007/12/1 00:00} that is the processed date and time (factor) from the search reservation dates and times (list) of the present entry in the scheduling table 152 (block D15). As a result, since the search reservation date and time is removed from the present entry, the same entry is erased from the scheduling table 152 (NO in block D16, block D17). The process explained up to now is the detail operation flow of block C5 of FIG. 11.

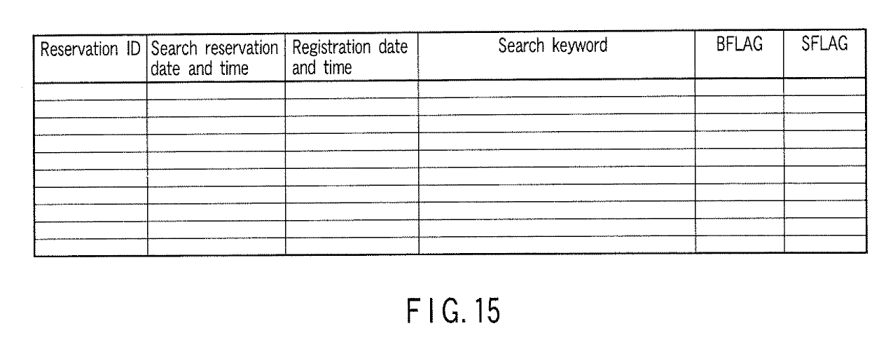

The explanation is made with reference to FIG. 11 again. The control module 111 extracts all of the entries from the scheduling table (YES in block C6) and, as a result, when all of the entries are deleted from the scheduling table (YES in block C7), the passive search flow is ended. In FIG. 15, the state of the scheduling table 152 after the process is shown.

If an entry remains in the scheduling table 152 at the stage of block C7 of FIG. 11 (NO in block C7), for example, the process starting from block C1 of FIG. 11 is performed again after a predetermined time interval has elapsed by performing a widely known interval timer process (block C8).

Thus, in the information search system to which the information processing apparatus (PDA 1) according to this embodiment is applied, information is obtained at the execution time of the search by inputting a search keyword and performing the search (active search) if the setting of the passive search is made. At this time, the future search can be reserved by use of the keyword and the re-search (passive search) can be automatically performed.

That is, the information search can be timely and automatically performed again by using a keyword input when the user performs a search without forcing the user to perform the operation of setting the keyword and the date and time at which the search is performed by use of the keyword.

### Second Embodiment

Next, a second embodiment of this invention is explained.

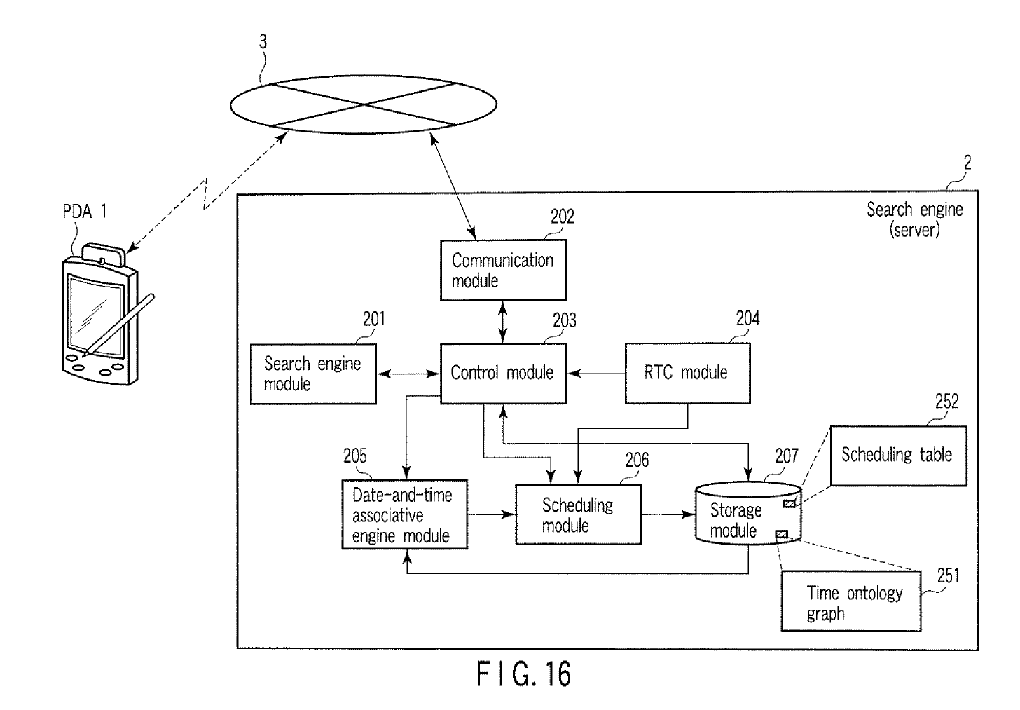

FIG. 16 shows an example of the configuration of an information processing apparatus according to the present embodiment and an example of the configuration of an information search system to which the information processing apparatus is applied. In this example, it is supposed that the information processing apparatus is realized as a search engine (server) 2 that is a Web site that provides service to search for information disclosed on an Internet 3 by using a keyword or the like.

As shown in FIG. 16, the server 2 includes a search engine module 201, communication module 202, control module 203, RTC module 204, date-and-time associative engine module 205, scheduling module 206, storage module 207 and the like. Among the above units, the communication module 202, RTC module 204, date-and-time associative engine module 205, scheduling module 206 and storage module 207 substantially correspond to the communication module 106, RTC module 112, date-and-time associative engine module 108, scheduling module 109 and storage module 110 provided in the PDA 1 of the first embodiment, respectively.

That is, the passive search function provided on the PDA 1 side in the information search system of the first embodiment is provided on the server 2 side in the second embodiment. The search engine module 201 performs an information search of searching for information that corresponds to a given keyword on the Internet 3.

The control module 203 in the server 2 manages a mail address of the user who wants to receive passive search service. When receiving an information search request from the user who wants to receive the passive search service, the control module 203 causes the search engine module 201 to instantly perform the information search using a transmitted keyword and, at the same time, causes the date-and-time associative engine module 205 and scheduling module 206 to perform the reservation process of the information search using the keyword. At this timer the control module 203 informs the scheduling module 206 of a mail address to be managed and causes the scheduling module 206 to register the mail address into a scheduling table 252. The scheduling table 252 in the second embodiment has an item (field) for recording a mail address of the user instead of “BFLAG” and “SFLAG” of the scheduling table 152 in the first embodiment shown in FIG. 3.

If newly received information is searched for when the passive search is performed based on the scheduling table 252, the control module 203 forms an electronic mail having a text in which, for example, a case name of “newly received information is present” and a uniform resource locator (URL) of the newly received information are listed and transmits the electronic mail to a mail address recorded in the scheduling table 252. The user who has received the electronic mail by means of a mailer such as the PDA 1 can refer to newly received information shown by a URL and listed in the text of the electronic mail by use of browser software.

In the second embodiment, since the passive search function is provided on the server 2 side, the load of the CPU such as the PDA 1 used by the user (to perform the passive search) and the storage capacity (to hold the time ontology graph and scheduling table) can be made unnecessary.

Further, since the server 2 which accepts information search requests from a large number of users uniformly manages the time ontology graph 251, it can be expected that it analyzes keywords transmitted from the users having various interests and search results based on a statistical method and optimizes the time ontology graph 251 based on the analysis result.

As described above, according to the information search system of the present embodiment, a date and time at which the information search is re-performed by use of the keyword input when the user has performed the information search is determined and the information search by use of the keyword is timely and automatically re-performed.

In the above embodiments, an example in which the passive search function is provided on the PDA 1 is explained, but it is of course possible to provide the passive search function on the portable telephone, desktop/notebook personal computer (PC) or the like.

Further, the time ontology graph 151 incorporated in the PDA 1 is used, but it is considered that the user adds or modifies the above graph or newly creates the graph by the user himself. In addition, the structure of the graph can be dynamically changed according to the feedback from the user. The graph can be downloaded from the server 2 or the like via the Internet and used, for example.

Also, in the above embodiments, the time ontology graph is searched for and the dates and times of the leaf node are uniformly registered in the data-and-time list. However, for example, variations in which the dates and times are weighted according to an evaluation function based on the distance from the intermediate node to the leaf node and registered in the priority order or three high-order dates and times are registered can be considered.

In the above embodiments, the passive search is performed by inputting characters, but it can be considered that the operation is performed by use of sound input. Further, the search result can be output not by using characters but by reading information based on a voice synthesizing process.

Further, in the above embodiments, reservation of the search is erased after the passive search is performed, but it is considered to repeatedly perform the search plural times according to the specification by the user. For example, Christmas is an event occurring on December of each year and it is considered that it is desired to perform the passive search over several years or it is desired to perform the passive search in each year until it is positively cancelled. Therefore, it is possible to specify repetition (continuation) of the passive searches.

In the above embodiments, for simplicity of the explanation, the passive search is performed by use of the date and time derived based on the time ontology graph. However, it is possible to perform a plurality of passive searches in an interval before and after the above date and time. For example, variations in which the passive search is performed every other day in an interval of two weeks before and after the derived date and time can be considered.

It is also possible to control timing at which the passive search is performed (to specify the time interval in which it is desired to present information or the time interval in which it is not desired to present information) in cooperation with the scheduler function (calendar) of the PDA 1. For example, it is possible to search for information in the morning of a holiday. Likewise, in the above embodiments, for simplicity of the explanation, an example in which the search result is displayed immediately after the passive search is performed is explained, but it is possible to shift the timings of the search and display operations.

Further, in the above embodiments, for simplicity of the explanation, whether or not information detected in the search is the newest information is determined according to the condition that the information registering date is within one month from the passive search. However, the above determination is made at the active search time, that is, according to the condition that the registration date is set after the search reservation date and time or it is also possible to permit the user to specify a desired period of time. It is considered that the periods may be defined for respective search keywords or categories and used.

In the above embodiments, for simplicity of the explanation, if the newest information is not detected at the search reservation date and time, a re-schedule process for the passive search is performed on the next day, but it is possible to permit the user to freely specify the interval of the re-schedule process.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information search method comprising:
performing an information searching process to search for information corresponding to an input keyword;
acquiring a date and time which is relevant to the input keyword, and recording the date and time together with the input keyword; and
re-performing an information searching process using the recorded keyword together with the date and time based on the recorded date and time.

2. The information search method of claim 1, further comprising filtering information detected by the re-performed information searching process based on a predetermined condition.

3. An information processing apparatus comprising:
a data communication module;
an information acquisition processing module configured to perform an Information acquisition process of acquiring information corresponding to an input keyword via an Internet by transmitting the keyword to a predetermined server apparatus on the Internet via the data communication module;
a scheduling module configured to acquire a date and time which is relevant to the input keyword, and to record the date and time together with the input keyword;
a control module configured to cause the information acquisition processing module to re-perform an information acquisition process using the keyword recorded by the scheduling module together with the date and time based on the date and time recorded by the scheduling module; and
an informing module configured to inform, when information is acquired by the information acquisition process which the control module causes the information acquisition processing module to re-perform, a user that the information is acquired.

4. The information processing apparatus of claim 3, wherein the scheduling module manages dictionary data to derive a date and time which is associated with a concept expressed by a given word for the word.

5. The information processing apparatus of claim 3, wherein the control module causes the information acquisition processing module to re-perform the information acquisition process using the keyword recorded by the scheduling module together with the date and time, when a predetermined execution condition is satisfied after the date and time recorded by the scheduling module.

6. The information processing apparatus of claim 3, wherein the control module causes the information acquisition processing module to re-perform the information acquisition process using the keyword recorded by the scheduling module together with the date and time for each predetermined timing specified according to a predetermined rule with the date and time recorded by the scheduling module set as a reference point.

7. The information processing apparatus of claim 3, wherein:
the scheduling module records a date and time at which the date and time and keyword are recorded as a registration date and time;
the control module includes a filtering module configured to exclude information acquired by the information acquisition process re-performed by the information acquisition processing module from a to-be-acquired object when a date and time held in the acquired information as attribute information is a date and time which comes before the registration date and time recorded by the scheduling module; and
the informing module performs the informing to the user when information which is not excluded by the filtering module and remains as a to-be-acquired object is present.

8. An information processing apparatus comprising:
a data communication module;
an information search processing module configured to perform an information searching process of searching for information corresponding to a keyword received via the data communication module from a client apparatus connected via an Internet on the Internet;
a scheduling module configured to acquire a date and time which is relevant to a keyword received by receiving module, and to record the date and time together with the received keyword;
a control module configured to cause the information search processing module to re-perform an information searching process using the keyword recorded by the scheduling module together with the date and time based on the date and time recorded by the scheduling module; and
an informing module configured to transmit, when information is searched for by the information searching process which the control module causes the information search processing module to re-perform, notification adding additional information for attaining the searched information to the client apparatus via the data communication module.

9. The information processing apparatus of claim 8, wherein the scheduling module manages dictionary data to derive a date and time which is associated with a concept expressed by a given word for the word.

10. The information processing apparatus of claim 8, wherein the control module causes the information search processing module to re-perform the information searching process using the keyword recorded by the scheduling module together with the date and time when a predetermined execution condition is satisfied after the date and time recorded by the scheduling module.

11. The information processing apparatus of claim 8, wherein the control module causes the information search processing module to re-perform the information searching process using the keyword recorded by the scheduling module together with the date and time for each predetermined timing specified according to a predetermined rule with the date and time recorded by the scheduling module set as a reference point.

12. The information processing apparatus of claim 8, wherein:
the scheduling module records a date and time at which the date and time and keyword are recorded as a registration date and time;
the control module includes a filtering module configured to exclude information acquired by the information searching process re-performed by the information search processing module from a to-be-searched object when a date and time held in the searched information as attribute information is a date and time which comes before the registration date and time recorded by the scheduling module; and
the informing module performes transmitting the notification to the client apparatus when information which is not excluded by the filtering module and remains as a to-be-searched object is present.
